(19) United States
(12) Patent Application Publication
(10) Pub. No.: US 2013/0198288 A1
(43) Pub. Date: Aug. 1, 2013

(54) Systems, Methods, and Computer Programs for Suspending and Resuming an Online Conference

(71) Applicant: American Teleconferencing Services, Ltd., Atlanta, GA (US)

(72) Inventors: Boland T. Jones, Atlanta, GA (US); David Michael Guthrie, Norcross, GA (US); Mark A. Sjurseth, Smyrna, GA (US); John P. Keane, Marietta, GA (US)

(73) Assignee: AMERICAN TELECONFERENCING SERVICES, LTD., Atlanta, GA (US)

(21) Appl. No.: 13/801,938

(22) Filed: Mar. 13, 2013

Related U.S. Application Data
(63) Continuation-in-part of application No. 12/790,193, filed on May 28, 2010.
Application No. 12/790,193 is a continuation-in-part of application No. 12/771,742, filed on Apr. 30, 2010.

(51) Int. Cl. H04L 29/06

(52) U.S. Cl. CPC H04L 65/1066
USPC 709/204

(57) ABSTRACT

Various embodiments of systems, methods, and computer programs are disclosed for joining an online conference already in progress. One such method comprises: a conferencing system establishing an audio conference between a plurality of participants accessing the conferencing system via a communication network; the conferencing system presenting to the participants via a graphical user interface the audio conference and a conference interface displaying a participant object identifying each of the participants; synchronously recording the audio conference with content presented in the conference interface; storing the synchronized audio conference and the content; during the audio conference, receiving from a new participant a request to join the audio conference already in progress; and in response to the request to join the audio conference, playing back the synchronized audio conference and the content presented in the conference interface to the new participant beginning from a recording start location.

### CROSS-REFERENCE TO RELATED APPLICATIONS

This application is a continuation-in-part patent application of and claims the benefit of the priority of the following patents applications, each of which is hereby incorporated by reference in its entirety: U.S. patent application Ser. No. 12/790,193, entitled “Record and Playback in a Conference” and filed May 28, 2010 (Attorney Docket No. 16003.1218U1); and U.S. patent application Ser. No. 12/771,742, entitled “Location-Aware Conferencing With Calendar Functions” and filed Apr. 30, 2010 (Attorney Docket No. 16003.1220U1).

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other multimedia, text, graphics, etc. These types of convenient conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of systems, methods, and computer programs are disclosed for suspending and resuming an online conference. One embodiment is a method for providing an online conference. One such method comprises: scheduling an online conference for a first scheduled date/time; a conferencing system establishing a first conference session for the online conference, at the first scheduled date/time, between a plurality of participants accessing the conferencing system via a communication network; during the first conference session: capturing content provided by one or more of the participants via a conference interface; storing the captured content in association with the online conference; determining that the online conference is to be suspended; and scheduling a second scheduled date/time when the online conference is to be resumed in a second conference session; the conferencing system ending the first conference session; at the second scheduled date/time, the conferencing system establishing the second conference session between at least a portion of the participants; and during the second conference session, presenting the captured content from the first conference session to one or more of the participants.

Another embodiment is a computer program embodied in a computer readable medium and executable by a processor for suspending and resuming an online conference initially scheduled for a first scheduled date/time. The computer program comprises logic configured to: establish a first conference session for the online conference, at the first scheduled date/time, between a plurality of participants; during the first conference session: present a conference interface to one or more of the participants; capture content provided by one or more of the participants via the conference interface; and schedule a second scheduled date/time when the online conference is to be resumed in a second conference session; establish the second conference session at the second scheduled date/time between at least a portion of the participants; and during the second conference session, present the captured content from the first conference session to one or more of the participants.

### BRIEF DESCRIPTION OF THE DRAWINGS

FIG. 1 is a block diagram illustrating an embodiment of a computer system for suspending and resuming an online conference provided by a conferencing system.

FIG. 2 is a combined data/flow diagram illustrating an embodiment of content shared by participants and captured during a first conference session of an online conference.

FIG. 3 is a flowchart illustrating the architecture, operation, and/or functionality of an embodiment of the computer system of FIG. 1 for suspending and resuming an online conference.

FIG. 4 is a combined data/flow diagram illustrating an embodiment of a method for suspending and resuming an online conference via the computer system of FIG. 1.

FIG. 5 is a combined data/flow diagram illustrating another embodiment of a method for suspending and resuming an online conference via the computer system of FIG. 1.

FIG. 6 is a user interface screen shot illustrating an embodiment of a conference interface implemented in the computer system of FIG. 1 for enabling a participant to suspend an expired conference.

FIG. 7 illustrates the conference interface of FIG. 6 for enabling a participant to schedule a resume date/time for a suspended conference.

FIG. 8 illustrates the conference interface of FIG. 6 for enabling a participant to save the resume date/time to a calendar.

FIG. 9 illustrates the conference interface of FIG. 6 after the conference is resumed.

FIG. 10 is a block diagram illustrating various embodiments of the types of content that may be captured during a conference.

FIG. 11 is a data diagram of an embodiment of a recorded conference illustrating a plurality of synchronized conference channels.

FIG. 12 illustrates an implementation of an interactive participant object in the conference interface of FIG. 6.

FIG. 13 illustrates another implementation of an interactive participant object in the conference interface of FIG. 6.

FIG. 14 illustrates an embodiment of an “invite” menu in the conference interface of FIG. 6 for enabling a participant to invite additional participants.

FIG. 15 illustrates an embodiment of a “share” menu in the conference interface of FIG. 6 for enabling a participant to share information resources with participants.

FIG. 16 illustrates the conference interface of FIG. 6 after the participant has inserted a web video.

FIG. 17 illustrates an embodiment of an “apps” menu in the conference interface of FIG. 6 for enabling participants to access conference apps.

FIG. 18 illustrates the conference interface of FIG. 6 after the participant has launched a conference notes application.

FIG. 19 illustrates an embodiment of a “record” menu in the conference interface of FIG. 6 for enabling a participant to launch a record/playback controller and configure record and alert options.

FIG. 20 illustrates an embodiment of a “record options” menu in the conference interface of FIG. 5.

FIG. 21 illustrates an embodiment of an “alert options” menu in the conference interface of FIG. 6.

FIG. 22 illustrates the conference interface of FIG. 6 with a record/playback navigation controller.

FIG. 23 is a more detailed illustration of the record/playback navigation controller of FIG. 22.

FIG. 24 is a flowchart illustrating the architecture, operation, and/or functionality of an embodiment of a method for recording and playing an online conference in the computer system of FIG. 1.

### DETAILED DESCRIPTION

Various embodiments of systems, methods, and computer programs are disclosed for suspending and resuming on online conference. The online conference may be scheduled, initiated, configured, operated, and/or controlled in the manner described in the above-referenced patent applications or otherwise. It should be appreciated that the online conference may provide a visually engaging conference experience to participants of a conference via a conference user interface presented to a client device. The conference interface may be used for conferences, meetings, groupings or other types gatherings (collectively, a “conference” with a system that provides the conference interface for a conference being referred to herein as a “conferencing system”) for any variety of purposes of one or more people, groups or organizations (including combinations thereof and collectively referred to as “participants”) with or without an audio component, including, without limitation, enabling simulcast audio with such conference for the participants. The conference interface may be configured to provide any desirable content and/or functionality and may support various user interface and/or conferencing features, including a conference suspend/resume functionality for enabling a participant host, other individual, or the conferencing system to suspend an online conference in progress and resume the conference at a later time.

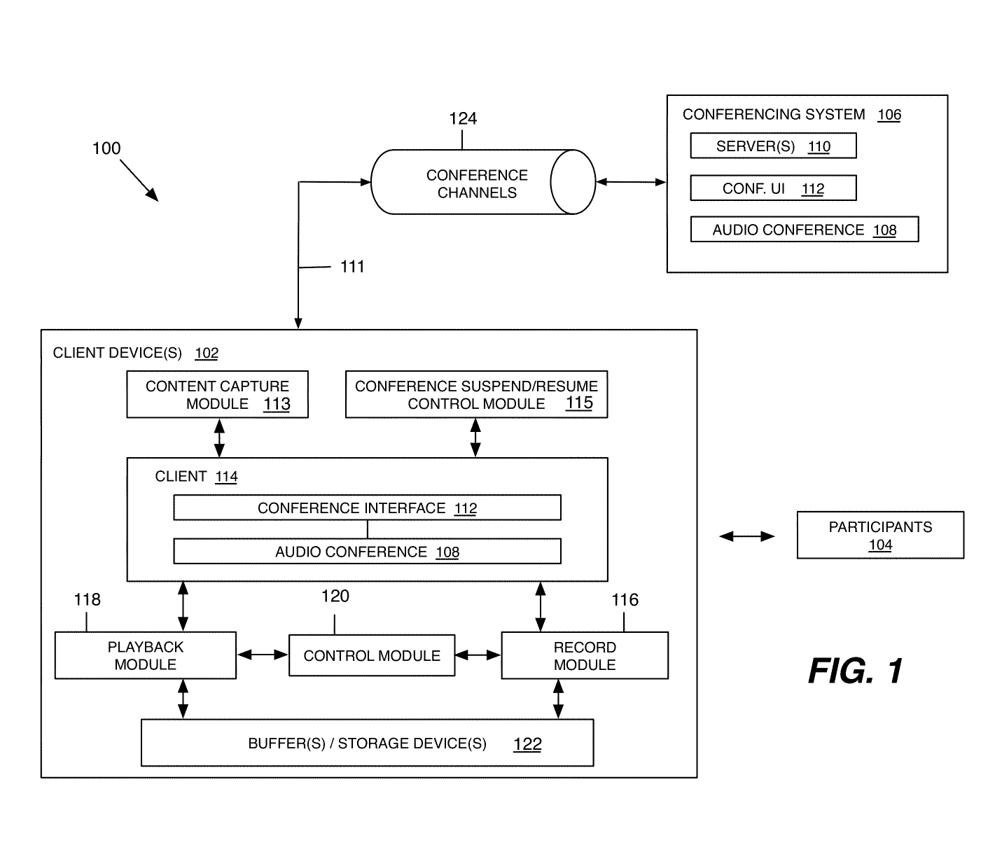

Various embodiments of the conference suspend/resume functionality are described below in more detail with reference to FIGS. 1-24. As an introductory matter, however, an exemplary embodiment of the conference suspend/resume functionality will be generally described. An online conference may be scheduled for a particular time (e.g., date, start time, end time, etc.). During the online conference, a participant may present or share content to one or more other participants via the conference interface. The shared content may supplement an audio conference and be captured and stored by the conferencing system. As described below in more detail, the shared content may be captured in various ways, including, for example, by recording the contents of the conference interface, monitoring one or more conference channels, or receiving data (e.g., audio, video, text, graphics, etc.) provided by the participants via the conference interface. The data may be provided, selected, inserted, or inputted by the participants using, for example, an appropriate conference application associated with the conference interface (e.g., an application for creating and/or sharing an email messages, instant messages, social networking messages, notes, collaboration data, etc.). In other embodiments, the data may be provided via an external application and then passed to the participant(s) and/or the conferencing system. In this document, the term “shared content” or “captured content” refer to all such types of data, information, or content.

For any number of reasons, the online conference may reach the scheduled end time or be terminated early without, for example, completing an agenda, current discussion, or otherwise completing the online conference. In such circumstances, it may be desirable to continue the online conference at a later time. Rather than having to schedule another online conference, the conference suspend/resume functionality enables the participants to: (1) suspend the online conference without losing the shared content; (2) schedule a follow-up meeting at a later date; and (3) resume the online conference at the later date while enabling the participants to access the shared content from the earlier meeting.

FIG. 1 illustrates an embodiment of a computer system 100 for enabling participants 104 to suspend and resume an online conference provided by a conferencing system 106. The computer system 100 comprises a conferencing system 106 and a plurality of client devices 102 connected via one or more communication networks 111. The network(s) 111 may support wired and/or wireless communication via any suitable protocols, including, for example, the Internet, the Public Switched Telephone Network (PSTN), cellular or mobile network(s), local area network(s), wide area network(s), or any other suitable communication infrastructure. The client devices 102 may be associated with corresponding participants 104 of an online conference, such as, an audio conference 108. A participant may comprise a “host” or “participant” and such terms merely refer to different user roles or permissions associated with the audio conference 108. For example, the “host” may be the originator of the audio conference 108 and, consequently, may have user privileges that are not offered to the participants, and the conference interface 112 may provide additional functionality not available to the other participants. Nonetheless, it should be appreciated that the terms “host,” “participant,” and “user” may be used interchangeably depending on the context in which it is being used.

The client devices 102 may comprise any desirable computing device, which is configured to communicate with the conferencing system 106 and the server(s) 110 via the networks 111. The client device 102 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device capable of communicating with the conferencing system 106 and/or the server(s) 110 via one or more networks 111. The client device 102 may include client software (e.g., a browser, plug-in, or other functionality) configured to facilitate communication with the conferencing system 106 and the server 110. It should be appreciated that the hardware, software, and any other performance specifications of the client device 102 are not critical and may be configured according to the particular context in which the client device 102 is to be used.

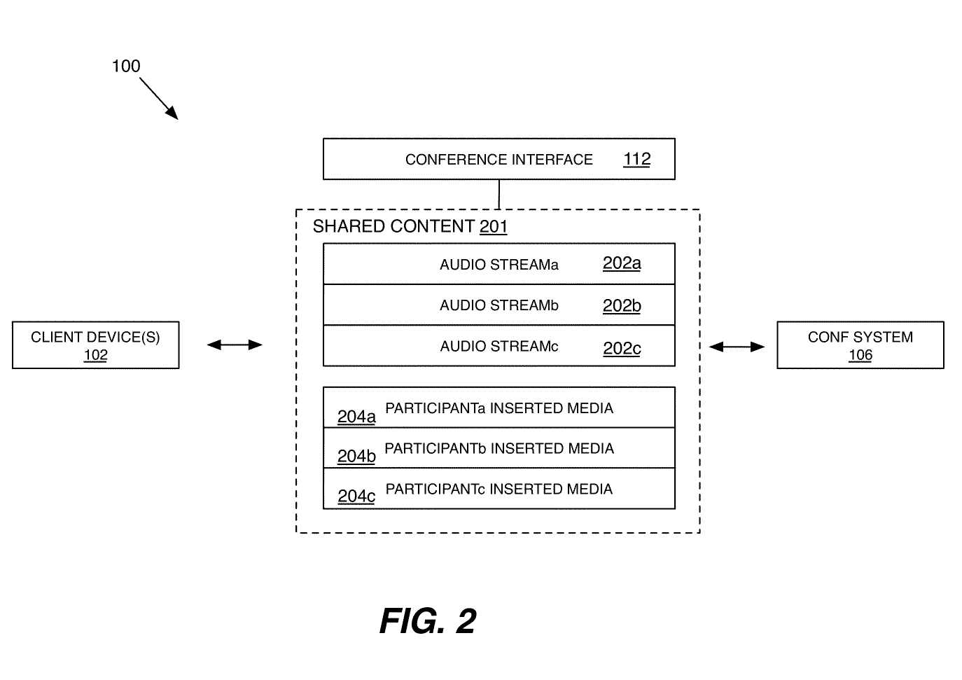

In the embodiment of FIG. 1, the conferencing system 106 generally comprises a communication system for establishing an online conference (e.g., an audio conference 108) between the client devices 102. The conferencing system 106 may support audio via a voice network and/or a data network. In one of a number of possible embodiments, the conferencing system 106 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 106 may support various alternative platforms, technologies, protocols, standards, features, etc. Regardless of the communication infrastructure, the conferencing system 106 may be configured to establish an audio connection with the client devices 102, although in some embodiments the audio portion may be removed. As illustrated in FIG. 2, the conferencing system 106 may establish the audio conference 108 by combining audio streams 202a-202c associated with, for example, client devices 102a-102c, respectively.

In general, the conferencing system 106 establishes an audio conference 108 between the participants 104. One or more server(s) 110 may be configured to present the audio conference 108 and a conference user interface 112 to the client device(s) via a client 114 (e.g., a browser, one or more browser plug-ins, and/or a special-purpose client). The conference user interface 112 may include logic located and/or executed at the client device 102, the conferencing system 106, or any combination thereof, and may be presented to and displayed via a graphical user interface and an associated display (e.g., touchscreen display device or other display device).

Referring again to FIG. 1, to facilitate various aspects of the conference suspend/resume functionality, the client device(s) 102 may comprise a content suspend/resume control module 115 and various modules for capturing the shared content, such as, a content capture module 113, a record module 116, a control module 120, a playback module 118, and one or more buffers or storage devices 122. These and other modules may be embodied in memory and executed by one or more processors. In one embodiment, the modules may be integrated with the client 114, although it should be appreciated that the modules may comprise separate modules that interface with the client 114, the graphical user interface, the conference user interface 112, or other associated software and/or hardware programs. Furthermore, it should be appreciated that one or more of these modules may reside at the server(s) 110 or other components in the conferencing system 106.

In general, the conference suspend/resume control module 115 comprises the logic configured to suspend an online conference and resume it at a later date. The content capture module 113 generally comprises the logic configured to capture the shared content during a first session of an online conference and then subsequently make it available to participants 104 after the online conference is resumed in a second session of the online conference.

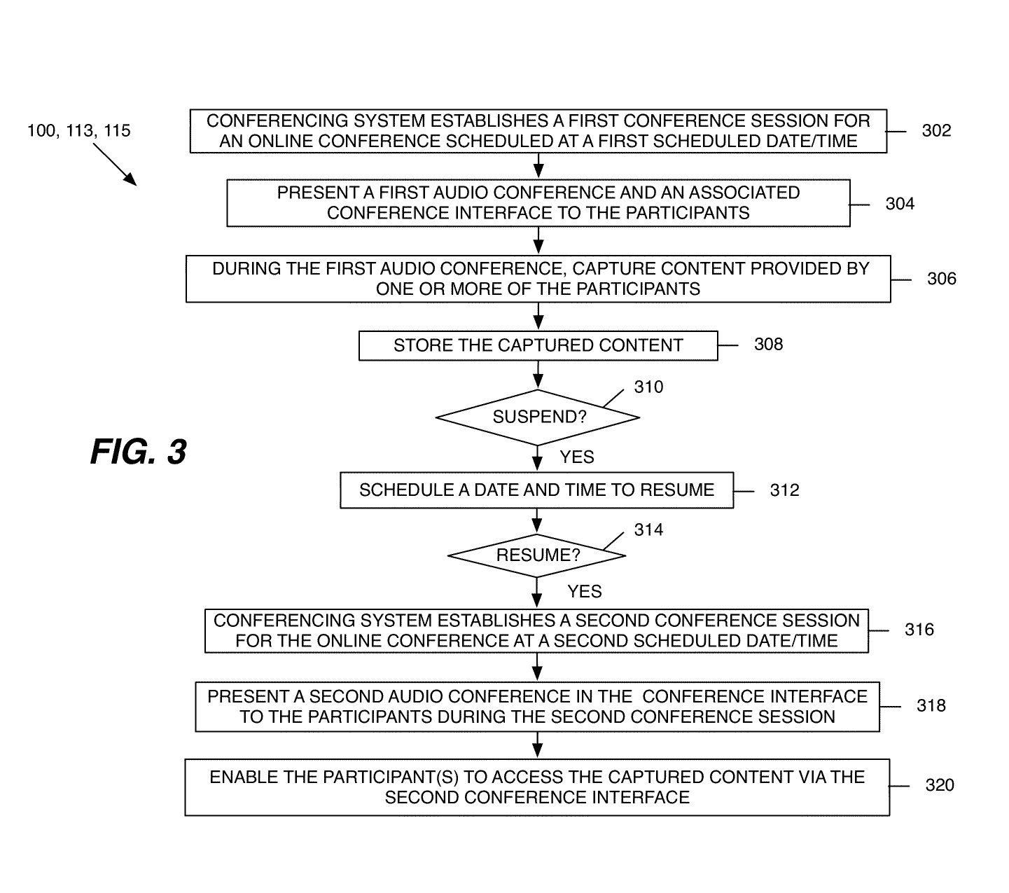

FIG. 3 is a flowchart illustrating the architecture, operation, and/or functionality of an embodiment of the computer system 100 of FIG. 1 for implementing the conference suspend/resume functionality. At block 302, the conferencing system 106 establishes a first conference session for an online conference between a plurality of participants 104 accessing the conferencing system 106 via a client device 102 having a connection to a communication network 111. The participants 104 may have scheduled the online conference for a first scheduled date/time (e.g., a particular date, starting time, ending time, etc.). In an embodiment, the first conference session may comprise a first audio conference 108a. The online conference may be scheduled in any desirable manner as provided by the conferencing system 106.

At block 304, the conferencing system 106 may present, for example, the first audio conference 108a and an associated conference interface 112 to the participants 104. During the first conference session, participant(s) 104 may provide the shared content via the conference interface 112, as described above. The shared content may be captured (block 306) by the conference interface 112 and provided to the conferencing system 106 for storage (block 308). It should be appreciated that the captured content may be stored or buffered locally at client device(s) 102 or stored remotely by the conferencing system 106 or other computer system.

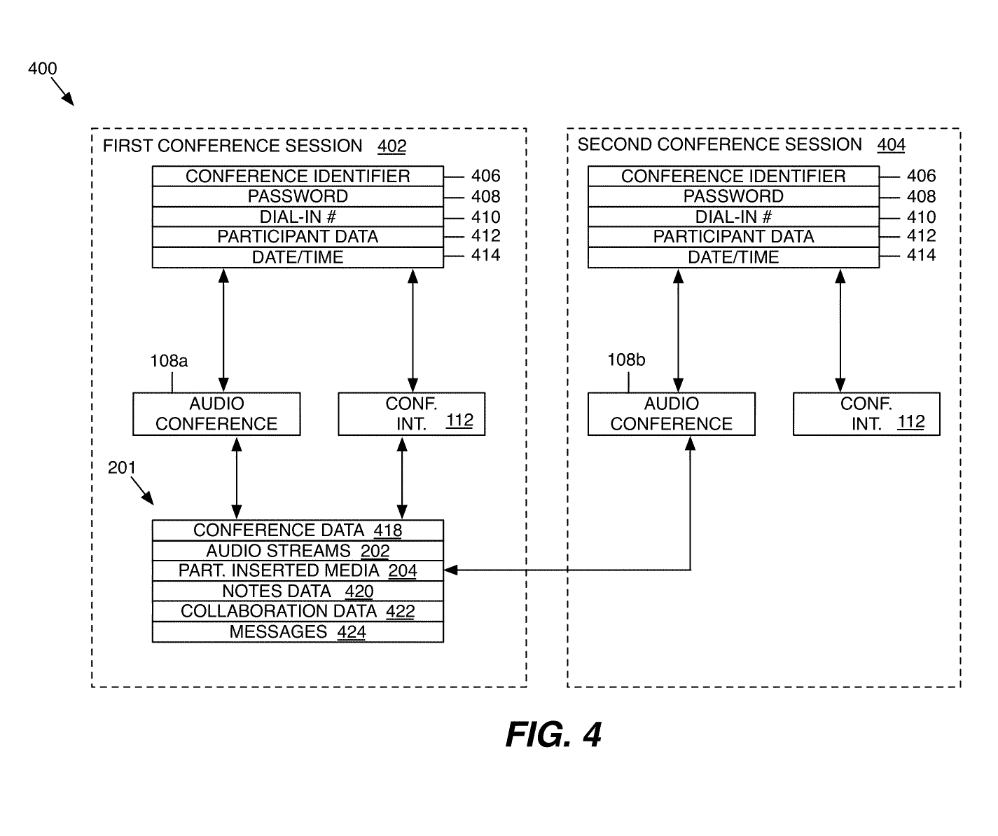

FIG. 4 is a combined data/flow diagram illustrating one embodiment of a data structure representing an online conference 400 that may be suspended and resumed. The online conference 400 comprises a first conference session 402 and a subsequent or second conference session 404. The first conference session 402 represents the initial conference at a first scheduled date/time. The second conference session 404 occurs after the first conference session 402 is suspended and the online conference 400 is resumed at a second scheduled date/time. The conferencing system 106 may create, store, and/or manage various stored data fields for scheduling, establishing, controlling, and/or managing the online conference 400. For example, in the embodiment illustrated in FIG. 4, the first conference session 402 comprises a conference identifier 406, a password 408, a dial-in number 410, participant data 412, a scheduled date/time 414, and any other suitable data.

The conference identifier 406 may comprise a unique identifier associated with the online conference 400. The dial-in number 410 and the password 408 may be distributed to the participants 104 and used to gain access to the online conference 400 via the conferencing system 106. For example, a participant 104 may dial the dial-in number 410, and the conferencing system 106 may prompt the participant to enter, for example, the conference identifier 406 and/or the password 408. As described in the above-referenced patent applications, however, it should be appreciated that, in other embodiments, the conferencing system 106 may dial-out to a phone number of the participants 104. The participant data 412 may comprise a list of participants 104 invited to participate in the online conference 400, as well as any desirable contact information (e.g., phone number, email address, social networking account information, etc.). The scheduled date/time 414 generally comprises the date and/or time at which the online conference 400 has been scheduled.

During the first conference session 402, the conferencing system 106 may present the first audio conference 108a and the conference interface 112 to the participants. As described above, the conferencing system 106 may capture and store shared content 201 (FIG. 2) via the conference interface 112. In the embodiment illustrated in FIG. 4, the shared content 201 comprises any conference data 418 presented in the conference interface 112, audio streams 202, participant inserted media 204, notes data 420 associated with a notes application, collaboration data 422 associated with a collaboration application (e.g., a whiteboard or brainstorming application), messages 424, or any other suitable data provided by the participants 104. The conferencing system 106 may logically associate the shared content 201 with the conference identifier 406 identifying the online conference 400.

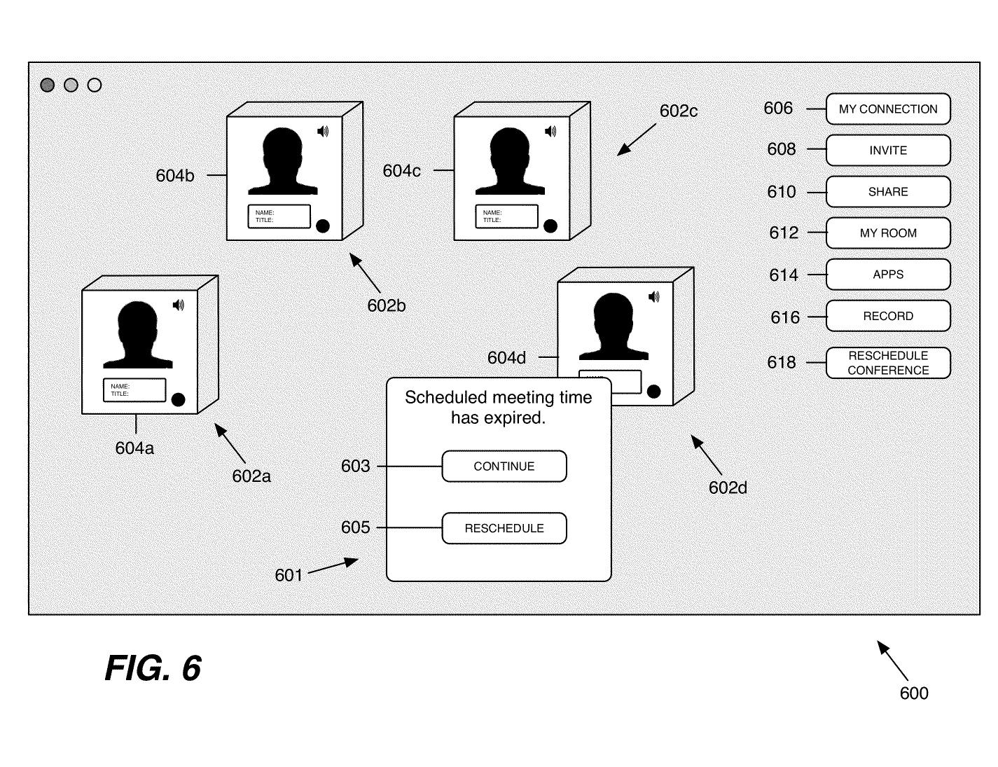

Referring to FIG. 3, as illustrated at decision block 310, during the first conference session 402 the online conference 400 may be suspended. There are a number of ways to determine that the online conference 400 is to be suspended. In an embodiment, the conferencing system 106 and/or the conference suspend/resume control module 115 may monitor the current time of the online conference 400 relative to, for example, a scheduled end time, and automatically notify participant(s) 104 that the scheduled meeting time has expired or is about to expire (FIG. 6). As illustrated in the embodiment of FIG. 6, the conference interface 112 may present an alert window 601 with a message indicating that the scheduled meeting time has expired. The alert window 601 may include a continue component 603 and a reschedule component 605. A participant 104 may select the continue component 605 to extend the online conference 400 beyond the scheduled meeting time rather than suspend/resume the online conference 400. If the online conference 400 is extended by selecting the continue component 603, the online conference 400 may be continued. The online conference may be continued for some predetermined amount of time (either a system default or according to a user profile), after which the alert window 601 may be presented again.

If a participant 104 selects the reschedule component 603 in the alert window 601 (or the reschedule conference menu 618), the online conference 400 may be rescheduled by specifying a second scheduled date/time when the online conference 400 is to be resumed in a second conference session 404. The second scheduled date/time may be automatically determined by, for example, accessing computer-based calendars of the participant(s) 104 and determining the availability of the participant(s) 104. The computer-based calendars may comprise a calendar maintained by the conferencing system 106, any online calendar, functionality, or service, or a local calendar stored on the client device(s) 102. In another embodiment, the second scheduled date/time may be determined by one or more participant(s) 104 via the conference interface 112.

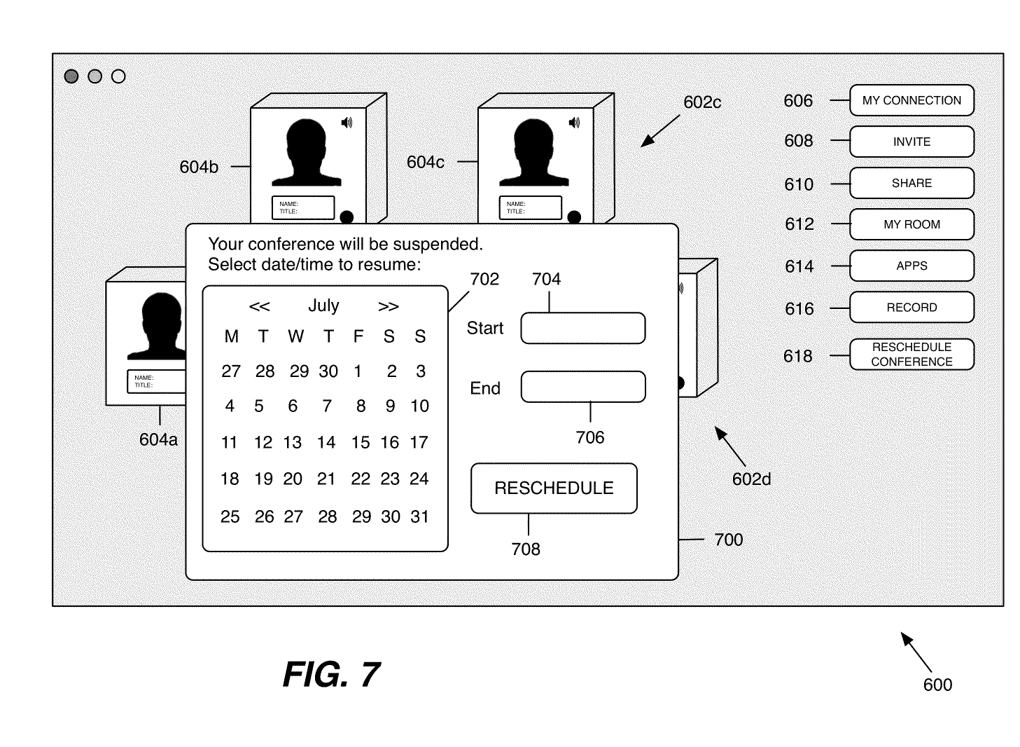

As illustrated in FIG. 7, the conference interface 112 may present a calendar functionality 700 for enabling participant(s) 104 to navigate a calendar component 702 (e.g., by month, week, etc.) and select a particular date, as well as specify a start time (input 704) and an end time (input 706). After specifying the second scheduled date/time when the online conference 400 is to be resumed, it may be confirmed by selecting a reschedule component 708. It should be appreciated that, in an embodiment, the calendar functionality 700 may be configured to receive proposed date(s) and/or time(s) from one or more participants 104 and facilitate agreement on the second scheduled date/time. In further embodiments, the calendar functionality for specifying the second scheduled date/time may be configured in the manner described in U.S. patent application Ser. No. 12/771,742, entitled “Location-Aware Conferencing With Calendar Functions,” which is hereby incorporated by reference in its entirety.

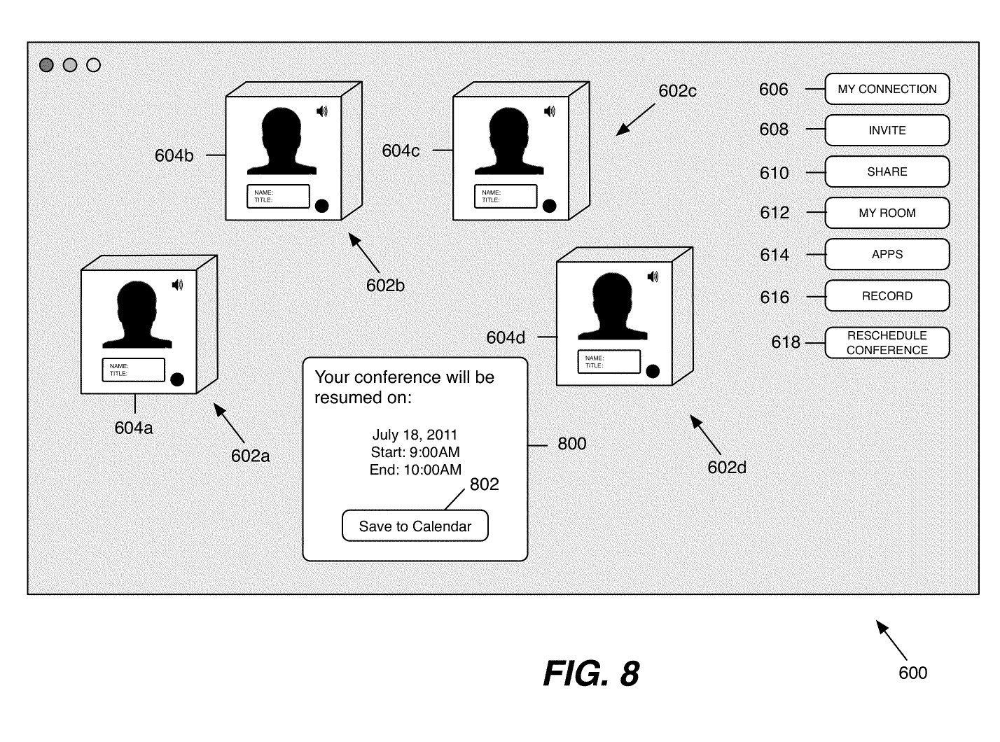

FIG. 8 illustrates an exemplary screen shot of the conference interface 112 in which a confirmation window 800 displays the second scheduled date/time for the second conference session 404. The confirmation window 800 may further comprise a “Save to Calendar” component 802, which enables participants 104 to add the second scheduled date/time to a calendar application residing on the client device(s) 102, the conferencing system 106, or any other calendar application or service (online or otherwise).

Referring again to the flow chart of FIG. 3, after the online conference 400 is rescheduled, the first conference session 402 (e.g., a first audio conference 108a) may be terminated by the conferencing system 106. As illustrated by decision block 314, the online conference 400 may be resumed, in a second conference session 404 (e.g., a second audio conference 108b) at the second scheduled date/time. One or more of the participants 104 from the first conference session 402 may participate in the second conference session 404.

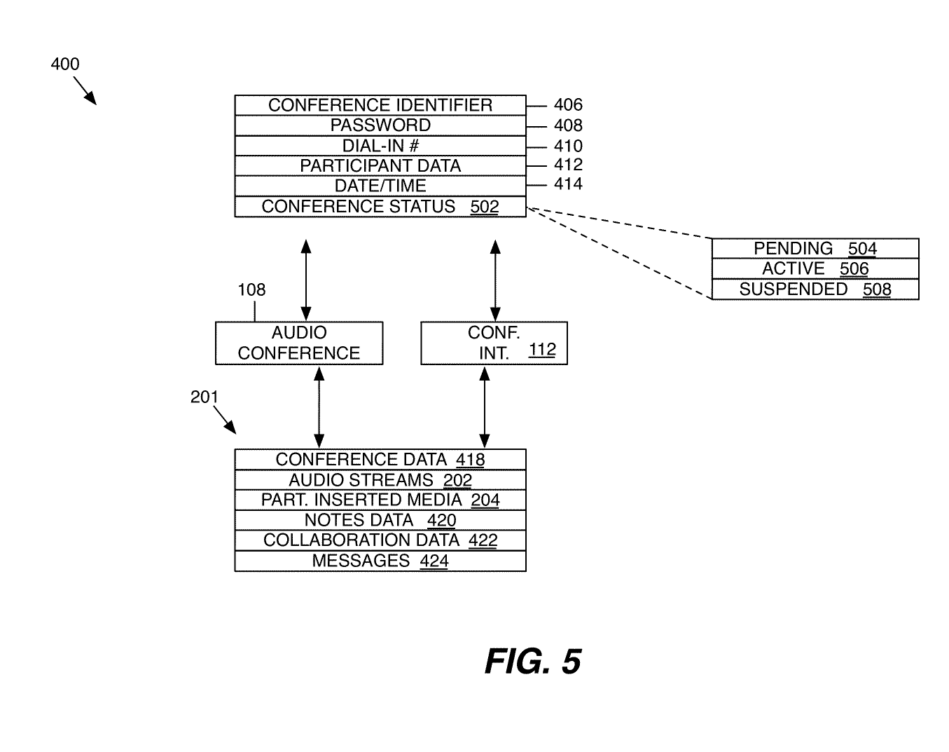

As illustrated in the embodiment of FIG. 4, the second conference session 404 may comprise similar data as used to establish, manage, and control the first conference session 402. The second conference session 404 may comprise a separate data record (FIG. 4) or the same data record as the first conference session 404 (FIG. 5). In the embodiment illustrated in FIG. 4, the second conference session 404 may store different data for one or more of the conference identifier 406, the password 408, the dial-in number 410, the participant data 412, or the scheduled date/time. In the embodiment of FIG. 5, the second conference session 404 is configured without a separate data record. Rather than creating a separate record, a conference status field 502 is used to manage the status of the online conference 400. The conference status field 502 comprises three states: a pending state (data field 504), an active state (data field 506), and a suspended state (data field 508). When the online conference is initially scheduled, the scheduled date/time 414 is configured with a first scheduled date/time and the conference status field 502 is set to the pending state. During the first conference session 402 at the first scheduled date/time 414, the conference status field 502 may be set to active state. If the online conference 400 is suspended, the conferencing system 106 may update the scheduled date/time 414 with the second scheduled date/time for the second conference session 404. The conference status field 502 may be set to the suspended state until the second conference session 404 is established, at which point the status may be changed to the active state. One of ordinary skill in the art will appreciated that various alternative means may be used to manage the first and second conference sessions.

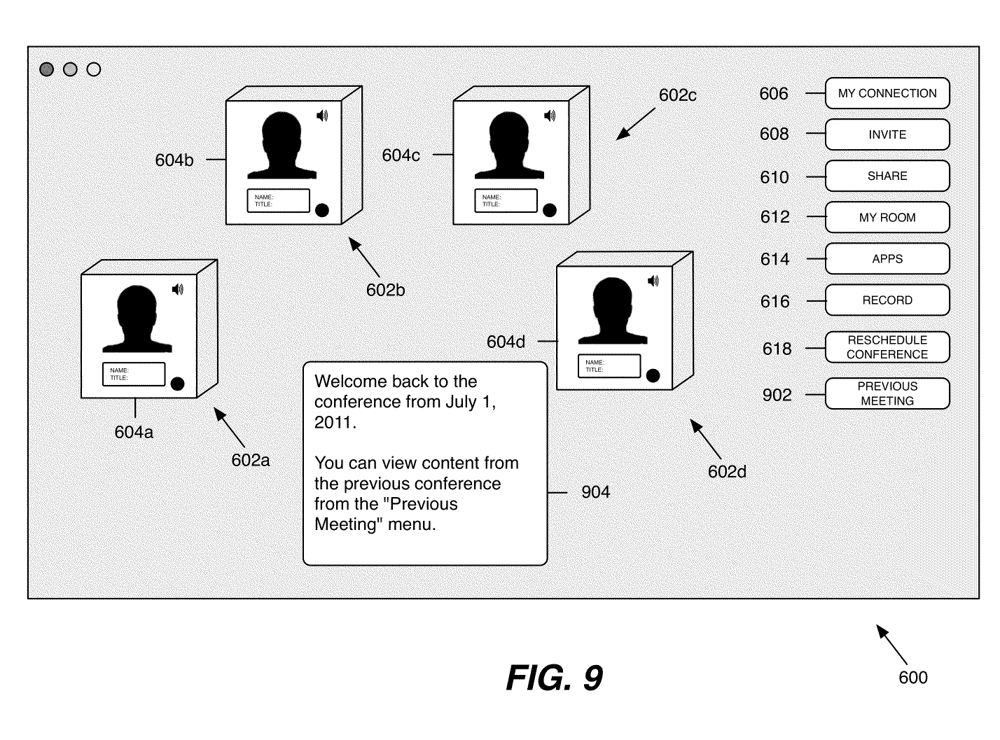

Referring again to FIG. 3, at block 316, the conferencing system 106 establishes the second conference session 404 (e.g., the second conference 108b) between at least a portion of the participants 104 during the second conference session 404. At block 318, the conferencing system 106 may present the second audio conference 108b and the conference interface 112 to the participants 104. FIG. 9 illustrates an exemplary screen shot of the conference interface 112, in which a window 901 displays a welcome back message. The message may reference the date/time of the first conference session to remind the participants 104. The window 901 may also present a help message notifying the participants 104 that the shared content 201 from the first conference session 402 has been transferred to the second conference session 404 and is available via the conference interface 112. The conference interface 112 may present a Previous Meeting menu 902 that enables the participants 104 to search, navigate, view, select, or otherwise access the shared content 201 captured during the first conference session 402.

Referring again to FIG. 3, at block 320, the conferencing system 106 may identify the shared content 201 captured during the first conference session 402 and enable the participants 104 to access the shared content 201 during the second conference session 404. It should be appreciated that the shared content 201 may be presented to the participants 104 in any desirable manner. In an embodiment, the shared content 201 from the first conference session 402 may be recorded, stored, and then subsequently played back when the online conference 400 is resumed in the second conference session 404. Referring again to FIG. 1, to record and playback the audio conference 108 and the content displayed or otherwise presented in the conference user interface 112, the client device(s) 102 may comprise a record module 116, a playback module 118, a control module 120, and one or more buffer(s) and or storage device(s) 122.

The record module 116 is configured to capture the shared content and/or functionality displayed or otherwise presented in the conference user interface 112 during the first conference session, including audio streams 202 (FIG. 2) in the audio conference 108 and any other audio, video, graphics, images, documents, text, data, or other multimedia presented via the conference user interface 112. A user of the client device 102 may selectively control the record module 116 via the control module 120 and an associated user interface. The record module 116 may store the captured content in one or more buffers or storage devices 122. In an embodiment, the captured content is buffered in real-time during the conference for immediate or subsequent playback by the playback module 118 during the second conference session 404, as described below in more detail. The record module 116 may comprise a screen capture functionality for capturing portions of (or the entire display region of) the conference user interface 112. The record module 116 may separately capture embedded audio and/or video content. At the conclusion of, or during, a conference, the captured content may be processed and stored in a playable format for storage, distribution, etc.

As illustrated in FIG. 1, the captured or shared content 201 may comprise data related to any of a plurality of conference channels 124 associated with the conference. Referring to FIG. 2, the conference channels 124 may comprise, for example, the audio streams 202 in the audio conference 108, the presentation content associated with the conference user interface 112, and any inserted media 204 from participants 104. The example illustrated in FIG. 2 comprises an audio conference 108 comprising three participants 104a-104c. Each participant has an associated audio stream 202a-202c. The inserted media 204 may comprise audio, video, documents, notes, images, graphics, data, etc. that a participant 104 may share, post, or otherwise present or display via the conference user interface 112.

In operation, each client device 102 in the computer system 100 may selectively capture one or more of the conference channels 124 for immediate or subsequent playback. The captured content may be stored on the respective client devices 102 or at the conferencing system 106. In this regard, the conferencing system 106 may include the record module 116 and the buffer(s) or storage device(s) 122.

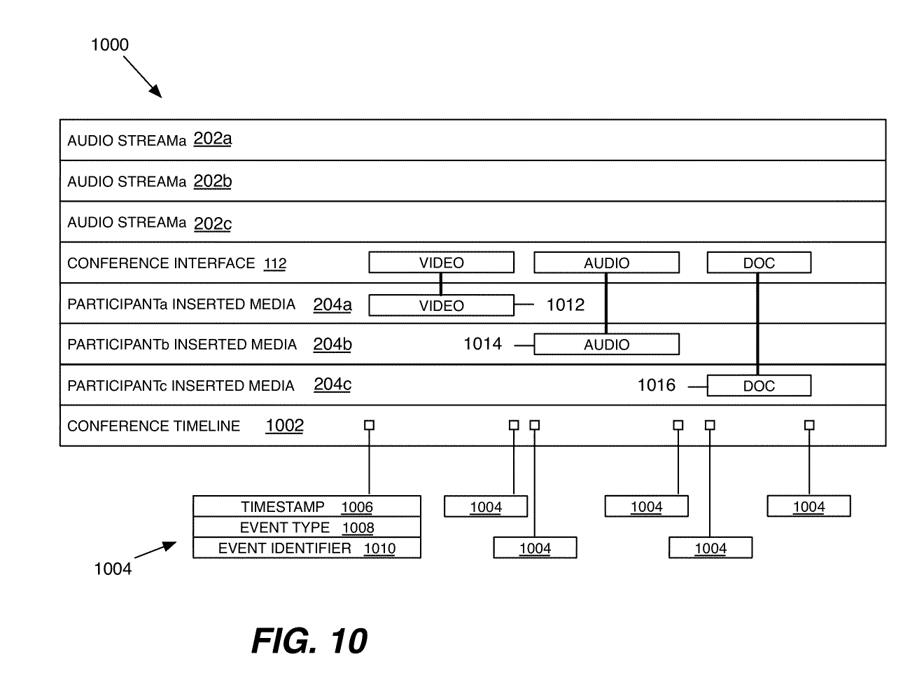

FIG. 10 illustrates an embodiment of a data structure for a recorded conference 1000, which has been recorded and stored via the computer system 100. The recorded conference 1000 may be stored in any storage device in any computer-readable format. In an embodiment, the recorded conference 1000 is configured as a playable media file or code. The recorded conference 1000 may be transferred or distributed between participants 104 or to other recipients using any desirable transfer or distribution method. In an embodiment, a participant 104 who recorded a conference may transfer the recorded conference 1000 to a participant profile or archive hosted by the conferencing system 106. The archive may store multiple recorded conferences 1000 for subsequent access (e.g., upon resuming the online conference 400 in the second conference session 404) and/or distribution by the participant 104 or any other users. The users may download the recorded conference 1000 for playback on a client device 102. In other embodiments, the recorded conference 1000 may be streamed as an integrated video. In further embodiments, the recorded conference 1000 may be referenced with a uniform resource locator (URL) or other embedded code that may be distributed to users. The participant 104 may also directly transfer or distribute the recorded conference 1000 to other users via any of the above-described or other methods, including by electronic mail or via a social networking computer system or third party video distribution system.

As illustrated in FIG. 10, the recorded conference channels 124 are synchronized according to a master timeline associated with the conference (e.g., conference timeline 1002). As part of the recording process, the record module 116 may generate timestamps 1004 for the recorded content. In an embodiment, the timestamps 1004 may include a time reference 1006, an event type 1008, and an event identifier 1010. The time reference 1006 defines a temporal location or position along the master timeline. The event type 1008 and event identifier 1010 may be used to catalogue specific types of events that occur in the conference. In the example illustrated in FIG. 10, a participant 102a may insert a video object 1012 in the conference interface 112. The video object 1012 may be shared with the other participants 102b and 102c via the conference interface 112, and an appropriate event type 1012 and event identifier 1010 may be created to identify the beginning and end of the inserted video. Later in the conference, the participant 102b may insert an audio object 1014, and the participant 102c may display a document object 1016. The record module 116 may generate a timestamp 1004 to identify the beginning and end of the inserted audio and document.

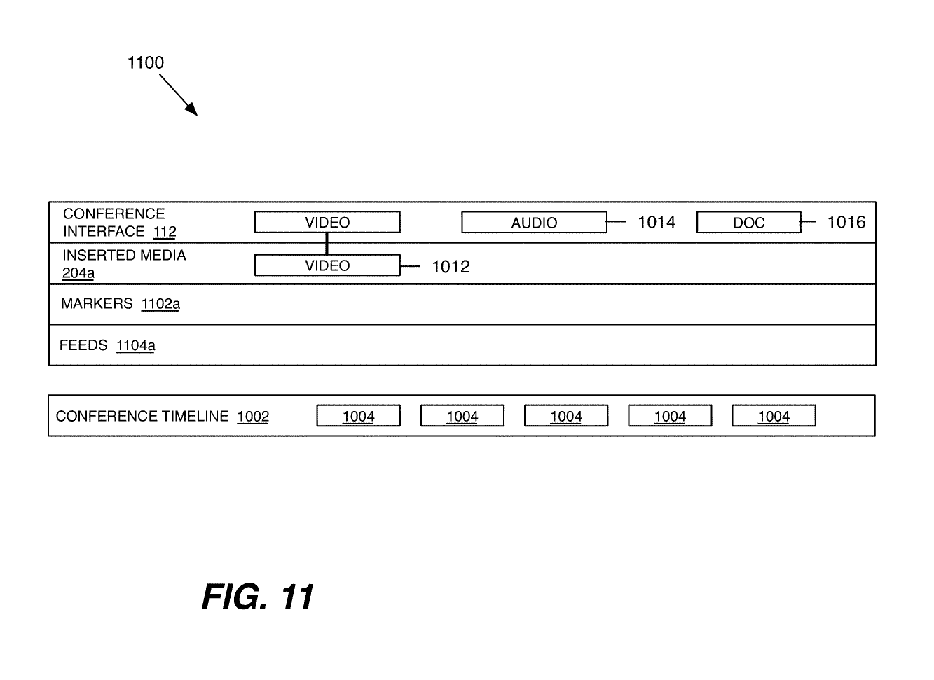

It should be appreciated that the record module 116 may be configured to generate timestamps 1004 for any conference event related to the conference interface 112. In the embodiment illustrated in FIG. 11, timestamps 1004 may be generated for participant-specified comments, notes, or markers 1102. The markers 1102 may be used to identify relevant points in the conference for subsequent review, or otherwise annotate the conference. Furthermore, timestamps 1004 may be generated to identify incoming and/or outgoing posts associated with a data feed, such as, for example, a communication channel related to a social networking system, in the manner described in the above-referenced international patent application. Timestamps 1004 for the markers 1102 and feeds 1104 may be categorized as private or public, which may define whether the channel components 124 are shared with other participants 104 or only available to the user who defined them.

Having described the general structure and operation of an implementation of a record/playback feature, various additional features and functions will be described with reference to an exemplary embodiment of a conference interface 600 (FIGS. 6 & 12). The conference interface 600 displays an interactive participant object 604 that identifies each participant 104 in the conference. The interactive participant object 604 may display similar information as described in the above-referenced international patent application (e.g., a graphical representation, profile information, an audio indicator, a business card component, etc.) and may implement similar or other user interface or other functions and features. In an embodiment, a business card component may “flip” the participant object 604 to display additional parameters. The interactive participant objects 604 may comprise further interactive functionality and visual effects. For example, the participant object 604 may comprise a cube having multiple display faces. When a participant 104 selects a user interface component, the cube may be expanded to display one or more faces of the object.

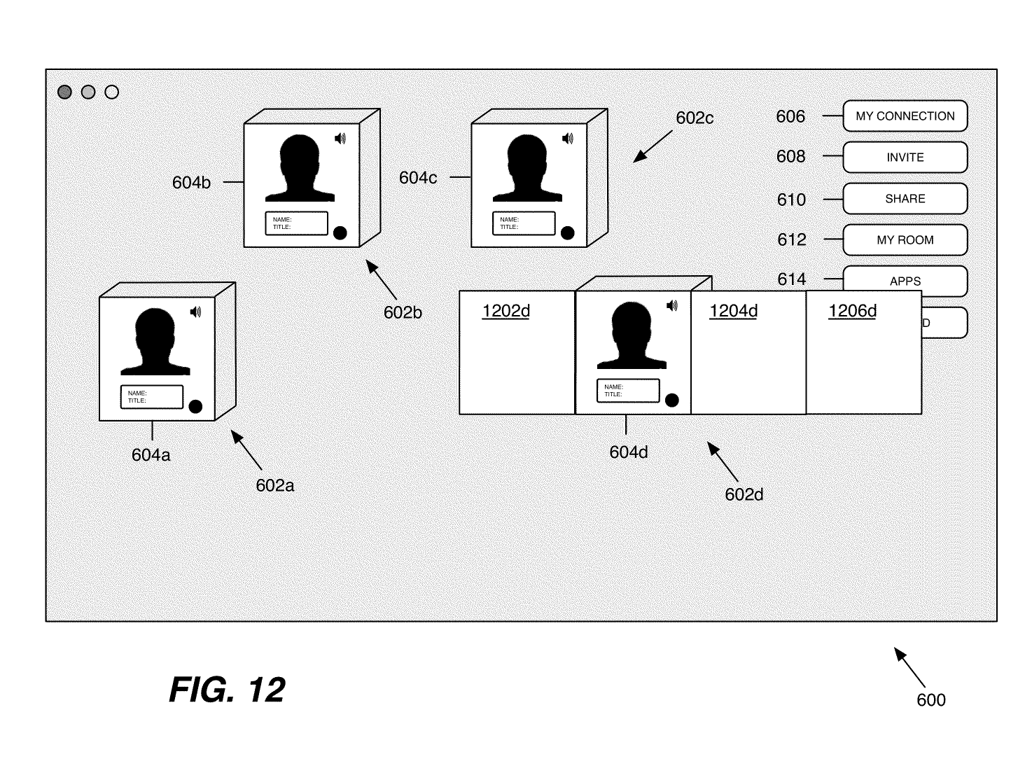

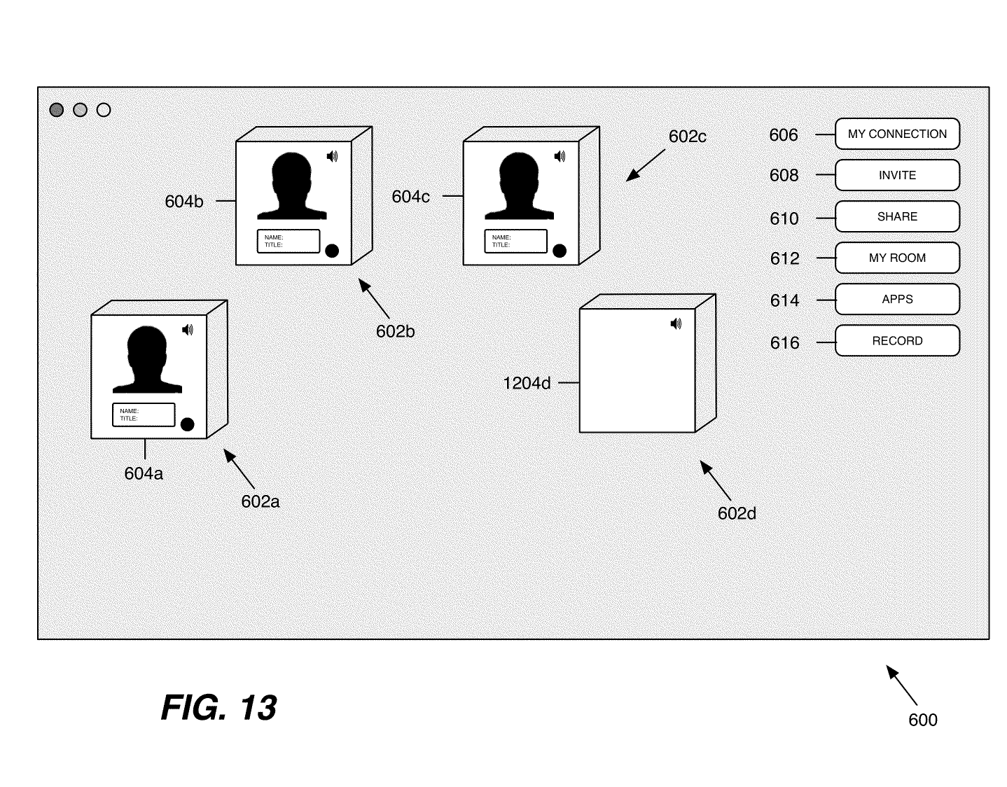

FIG. 12 illustrates the participant object 604d after is has been selected by one of the participants. The user selection may trigger the display of cube faces 1202d, 1204d, and 1206d. Each face may display additional information about the associated participant. In an embodiment, the cube faces may be configurable by the participant and may display, for example, a social networking profile, updates to a social networking communication channel, video, graphics, images, or any other content. The cube faces may be further selected to return to the original collapsed cube. In another embodiment, the participant object 602 may be rotated (either automatically or via user selection) to display the respective cube faces 604d, 1202d, 1204d, and 1206d. FIG. 13 shows the participant object 502b after it has been rotated to display cube face 1204d. It should be appreciated that the participant objects 602 may be configured with additional or alternative visual effects and/or interactive functionality.

The conference interface 600 may comprise one or more selectable components for accessing various features. A my connection component 606 may launch a display for enabling a participant 104 to configure the existing connection between the client device 102 and the conferencing system 106. The participant 104 may disconnect a connection to the audio conference 108, establish a new connection to the audio conference 108 (e.g., by dial-out), or reconfigure the existing connection to the audio conference 108. In addition to configuring the audio connection, the participant 104 may also configure the connection to the online conference via the conference interface 600. In an embodiment, the connection to the online conference may be transferred to another client device 102 or another client 114 on an existing or other client device 102. This may enable the participant 104 to seamlessly maintain a presence in the online conference during the transfer.

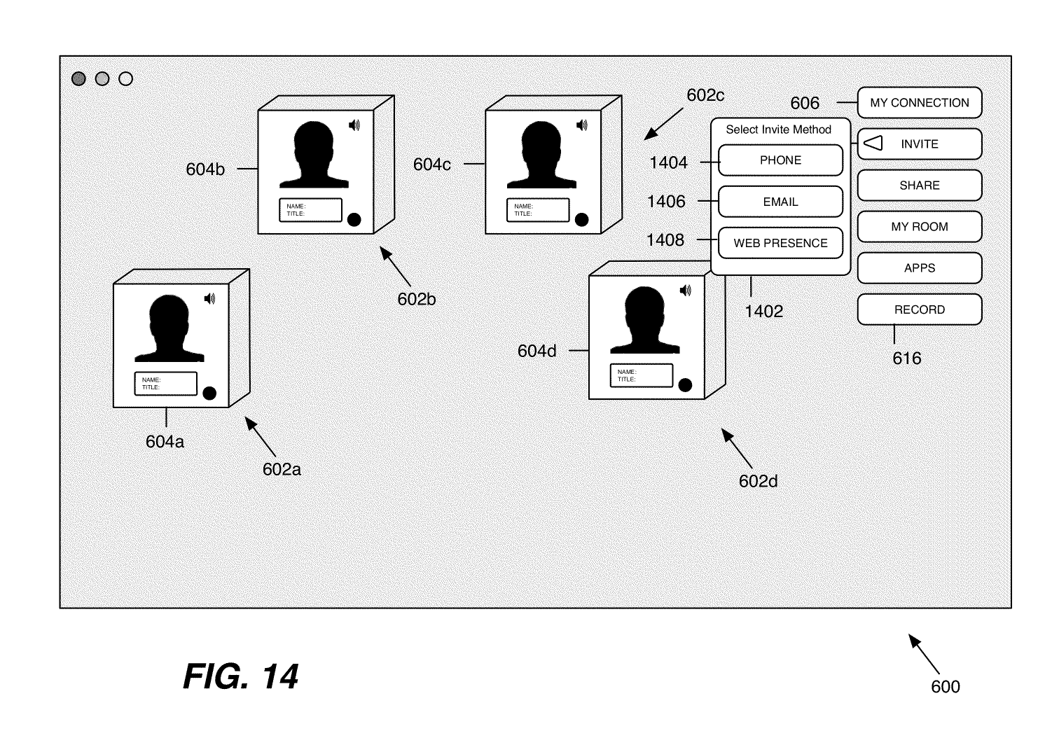

An invite component 608 may launch a menu 1402 (FIG. 14) for enabling a participant 104 to invite additional participants 104 to the online conference. As illustrated in FIG. 14, additional participants may be invited by, for example, dialing out to a telephone number (phone component 1404), sending an email including information for accessing the conferencing system 106 (email component 1406), or sending a message to a web service (web presence component 1408), such as, for example, a social networking system.

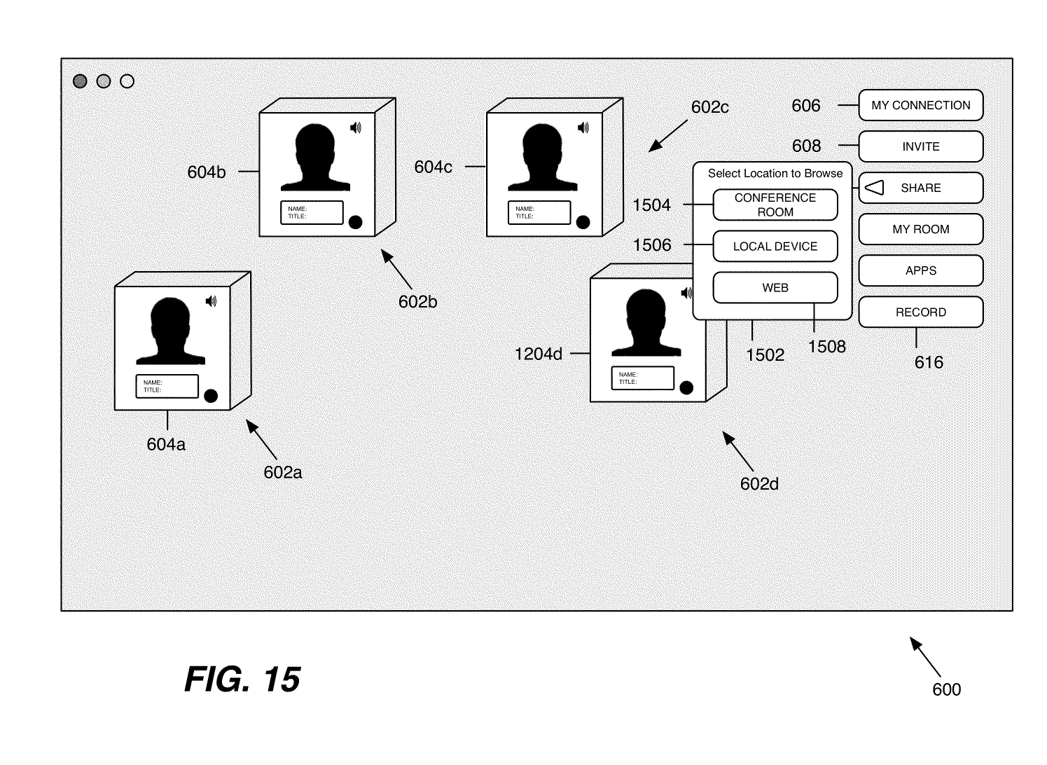

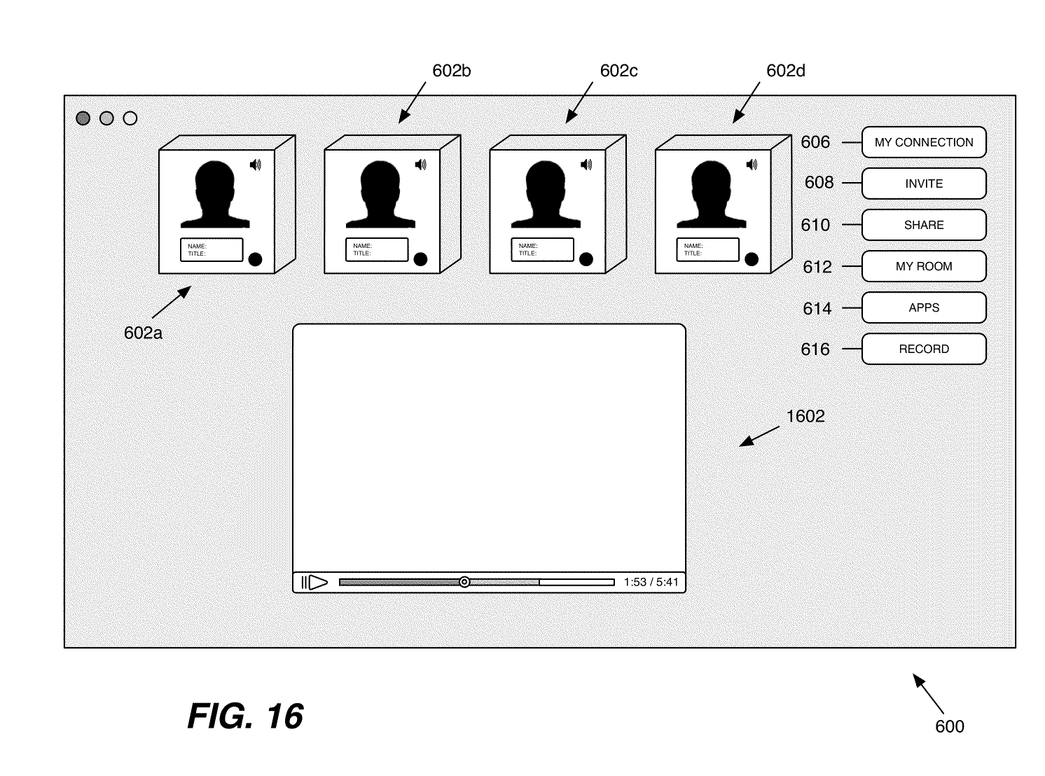

A share component 610 may launch a menu 1502 (FIG. 15) for enabling a participant 104 to insert and share media with other participants in the online conference. The menu 1502 may prompt the participant 104 to specify a browse location for selecting the media. A conference room component 1504 may display media stored by the conferencing system 106. A local device component 1506 may display a file browser for enabling the participant 104 to select files located on the client device 102. A web component 1508 may display available media hosted by a web service, such as, for example a third party video, audio, or document hosting service. FIG. 16 illustrates the conference interface 600 after a participant 104 has identified a web-based video 1602. The client device 102 may launch the web-based video 1602 and the conferencing system 106 shares it with all of the participants 104 via the conference interface 600.

In an embodiment, when the participant launches the web-based video 1602 (or other user interface component, presentation display, etc.), the component may be introduced in the conference interface 600 as a “fly-in” component to provide a more visually engaging experience. For instance, the component may appear to be raised from a bottom portion of the conference interface 600 and the participant objects 602 may be automatically rearranged in the remaining available screen space (or hidden) to accommodate the component. The movement of the component may originate from any portion of the screen and may implement any desirable animation or effects. In one implementation, the “fly-in” component is configured to simulate the motion of a physical screen being raised from the “floor” of the screen, with the participant objects 602 being “pushed aside” by the display or otherwise rearranged or hidden. In another embodiment, the participant objects 602 may be displayed in the background with the “fly-in” component being raised in the foreground.

When the web-based video 1602 (or other presentation display) is completed or otherwise deactivated manually or automatically, the animation or effects may be reversed and the participant objects 602 returned to an original or other layout and the “fly-in” component moved to the original or other state. It should be appreciated that the “fly-in” component animation and/or effects may be used with any desirable presentation content and/or functionality (e.g., a display, pane, window, etc.).

A my room component 612 may launch a display for enabling a participant 104 to configure the appearance of the conference interface 600. The participant 104 may configure the arrangement of the participant objects 602, specify a location view (as described in the above-reference international patent application), or configure any other presentation parameter.

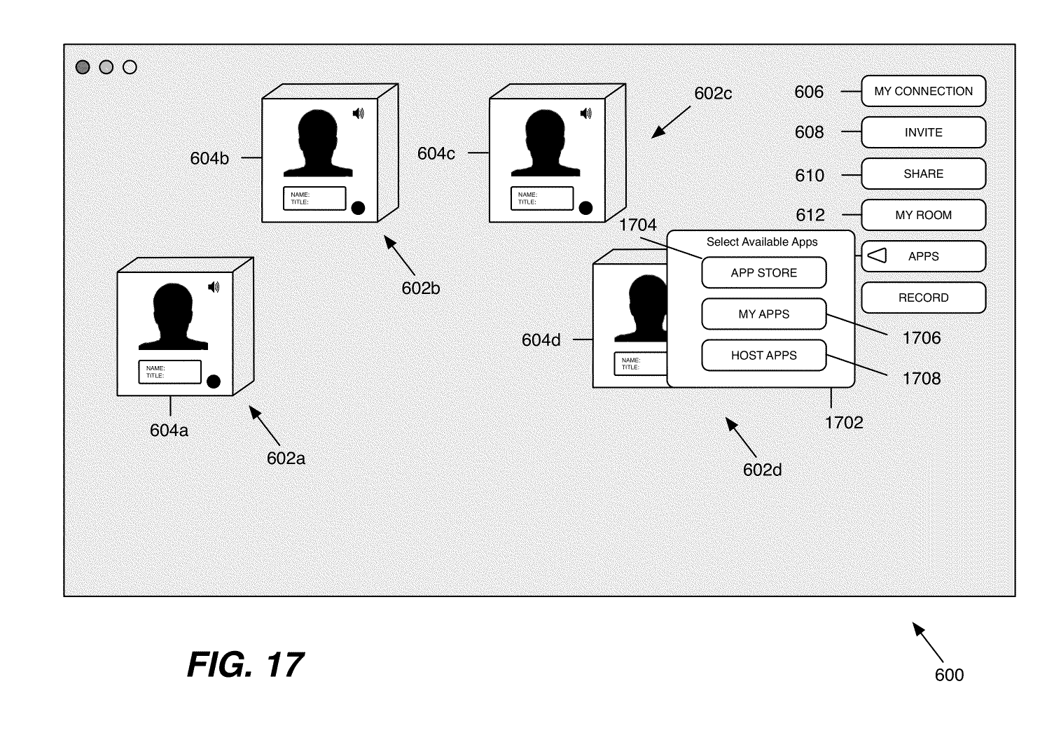

An apps component 614 may launch a menu 1702 (FIG. 17) for enabling a participant 104 to launch conference applications. As described above, the conferencing system 106 may host a conference apps store for purchasing various conference applications. An app store component 1704 may launch the app store where the participant 104 may purchase conference applications. A my apps component 1706 may launch a display for enabling the participant 104 to select from applications that have already been purchased or are otherwise available to the participant 104. A host apps component 1708 may display conferencing applications that have been made available by the host of the online conference.

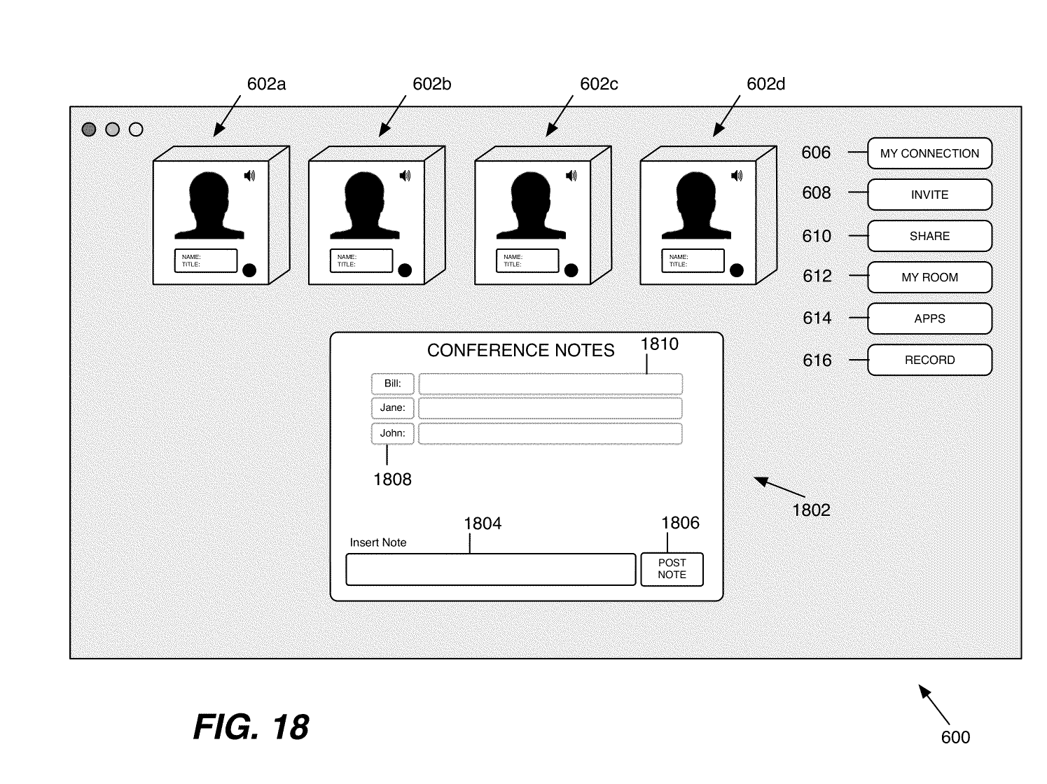

FIG. 18 illustrates the conference interface 600 after the participant 104 has launched a conference notes application 1802. The notes application 1802 displays a text insertion component 1804 for enabling participants 104 to insert notes to a notes section. A participant 104 may insert a note and select the post note component 1806, which adds as a group note 1810 with an indication 1808 of the participant 104.

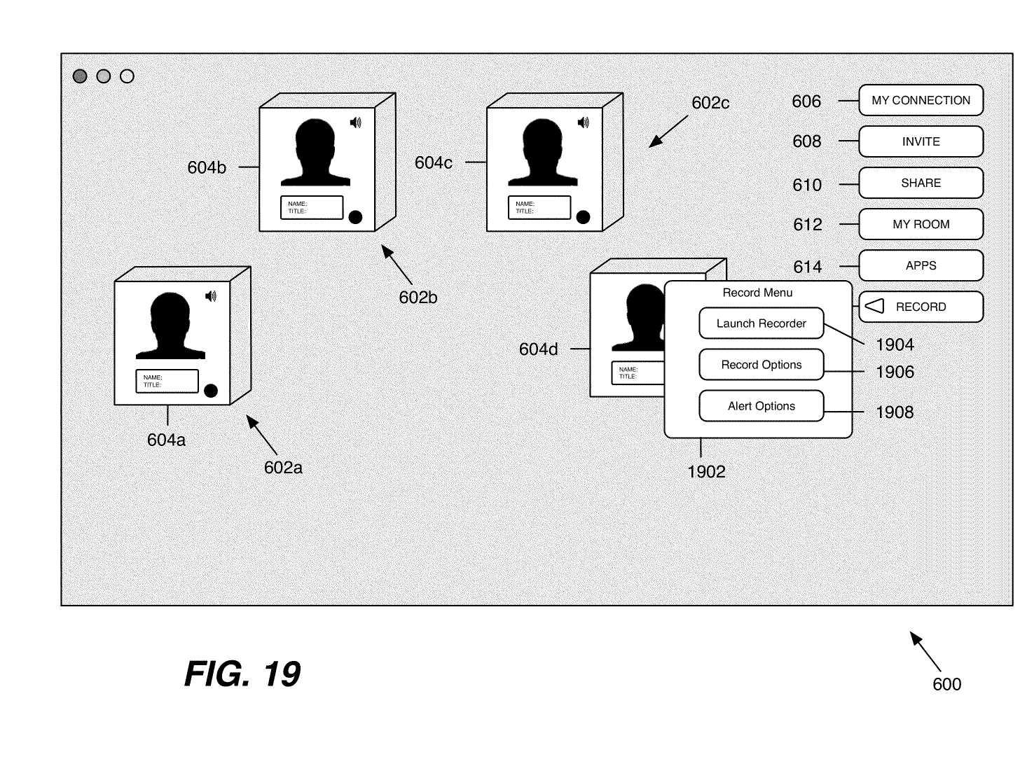

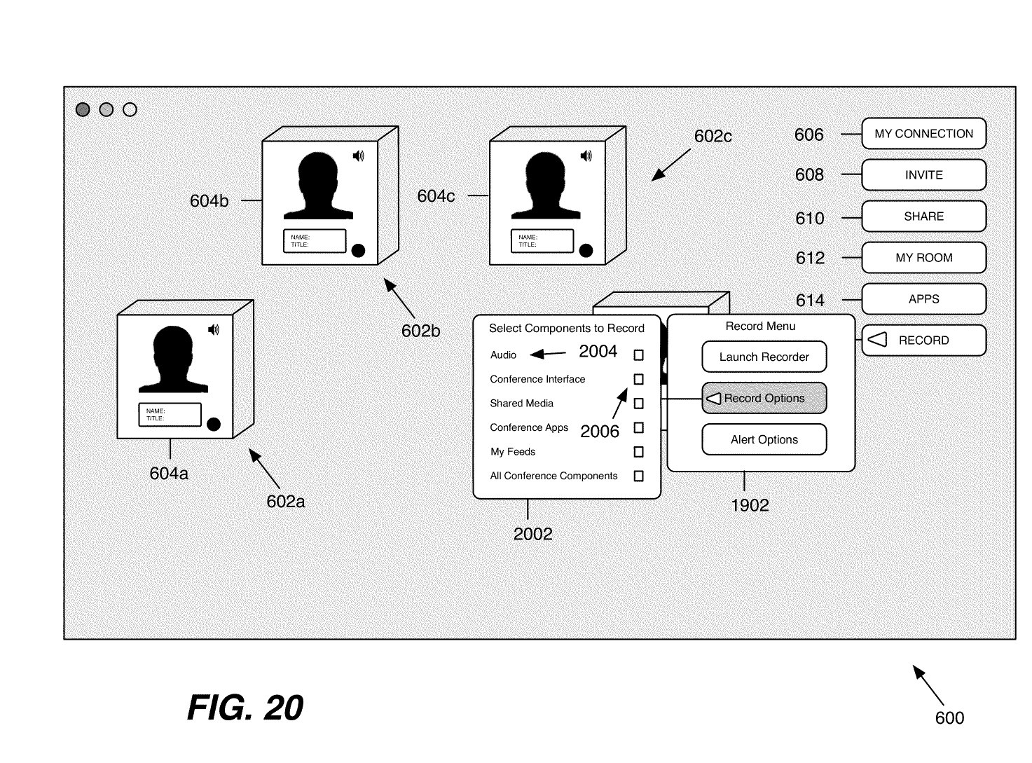

A record component 616 may launch a display 1902 (FIG. 19) for enabling a participant 104 to launch a conference recorder (component 1904) or configure record options (component 1906) or alert options (1908). As illustrated in FIG. 20, the record options component 1906 may launch a display 2002 for enabling participants 104 to select (e.g., via check boxes 2006) which components 2004 of the online conference to record. In the embodiment illustrated in FIG. 20, the participant 104 may select to record according to one or more of the following parameters: audio, conference interface, shared media, conference apps, my feeds, or all conference components. When activated, the record module 116 (FIG. 1) will record and store the selected components.

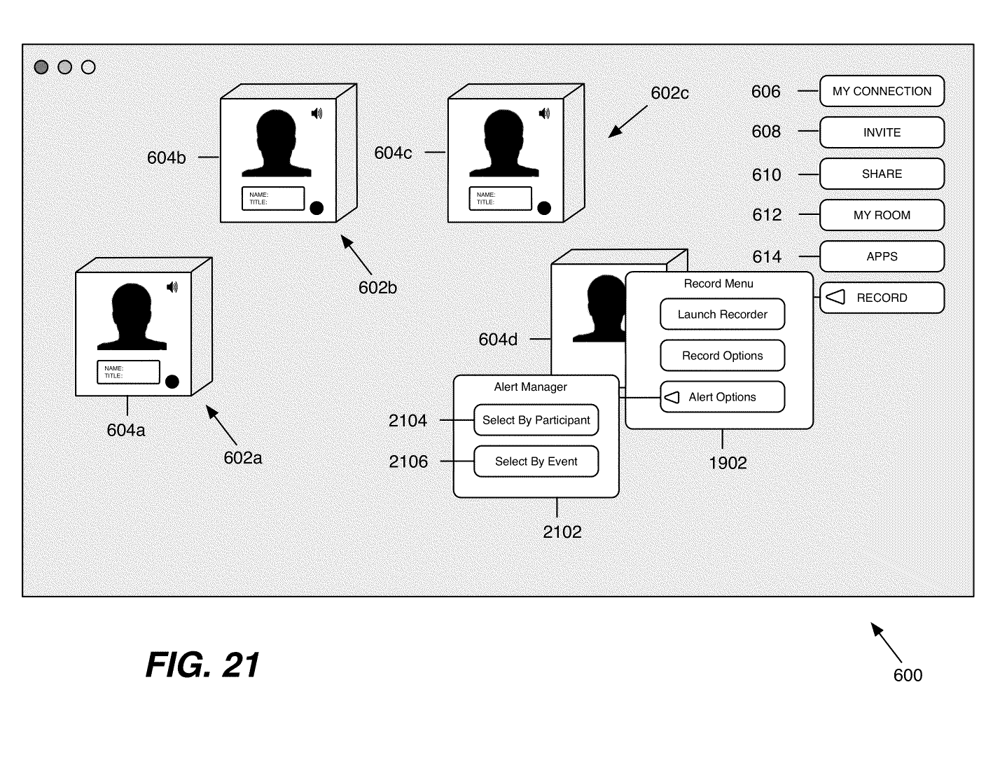

As illustrated in FIG. 21, the alert options component 1908 may launch an alerts manager 2102 for enabling the participants 104 to configure the conference interface 600 for various in-conference alerts. For example, the conference interface 600 may be configured to alert the participant when certain events occur in the conference (component 2106) such as, for example, when a video is shared, a conference application is launched, etc. Other types of participant-based alerts may be generated (component 2104). The participant 104 may wish to be alerted via the conference interface 600 when a particular participant 104 is speaking or when the participant takes a certain action in the conference.

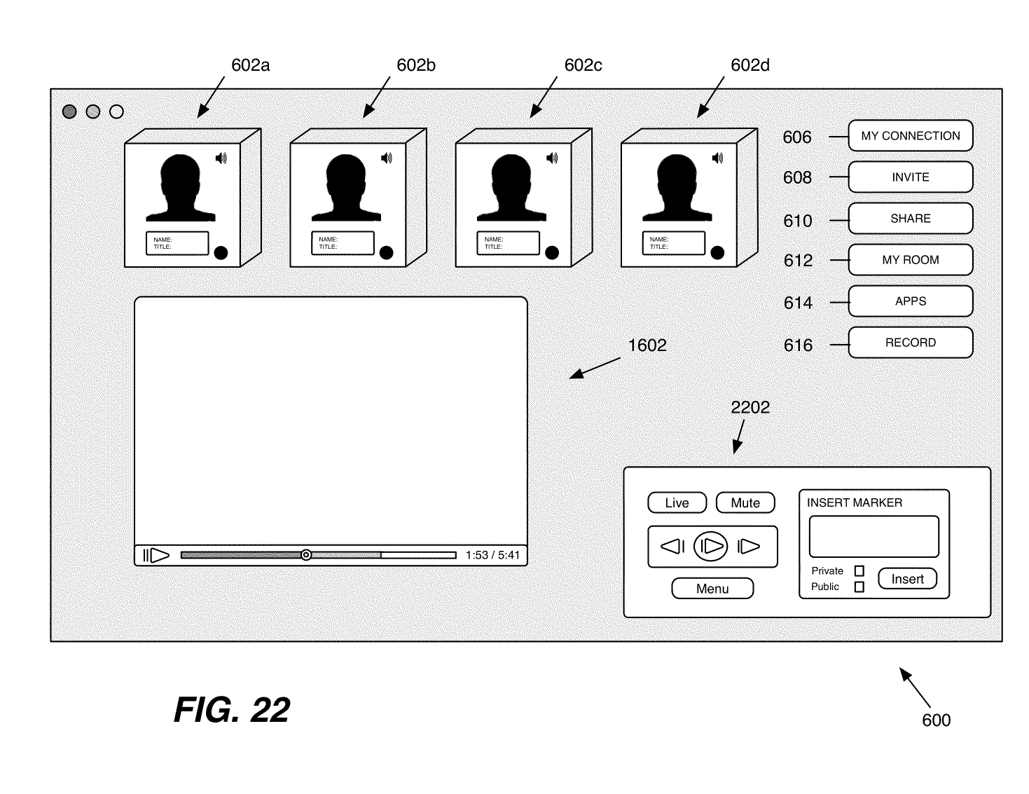

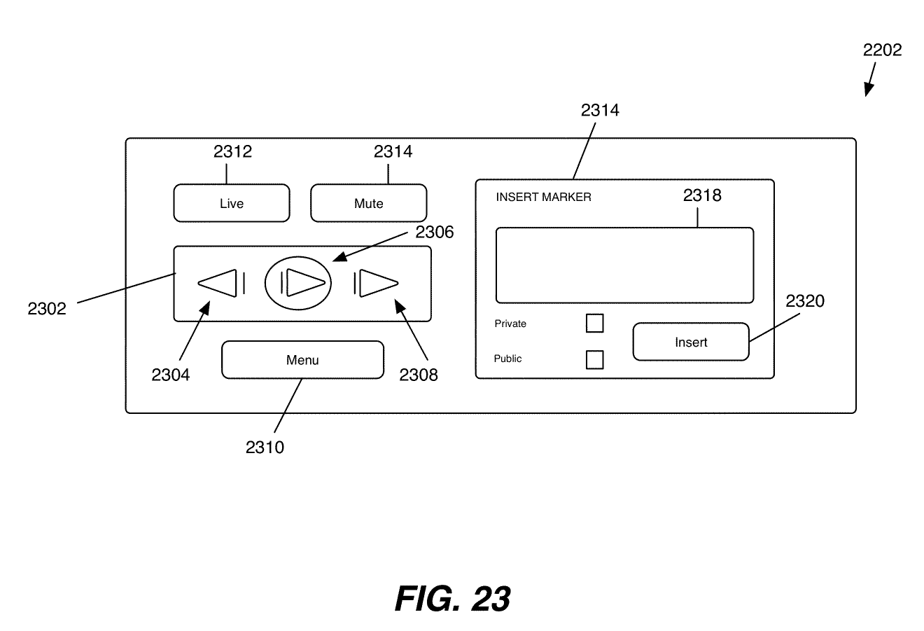

When the conference recorder is launched and the record module 116 is recording the conference, the conference interface 600 may present a record/playback navigation controller 2202 (FIG. 22) for facilitating various record and playback features. The record/navigation controller 2202 comprises the user interface associated with the control module 120 (FIG. 1). As illustrated in the embodiment of FIG. 23, The controller 2202 comprises a navigation controller 2302 comprising a pause/play input 2306, a rewind input 2304, and a forward input 2308 for initiating the respective playback functions. The pause/play input 2306 toggles between the functions of pausing the conference and playing the conference. The rewind input 2306 and the forward input 2304 enable the participant 104 to navigate to earlier and later locations or positions on the conference timeline 1002 (FIG. 10) of the conference during playback. During the playback function, a participant 104 may select the live input 2312 to automatically return to a current location or position on the conference timeline 1002 (generally referred to as “going live” in the online conference). The mute input 2314 mutes the audio conference 108.

The record/playback navigation controller 2202 may further comprise an insert marker portion 2314 for enabling participants 104 to insert comments, tags, etc. (markers 1102-FIG. 11) into the conference timeline 1002. The comment may be added to a text insertion component 2318 and specified as a private or public comment via, for example, applicable check boxes or other controls. When the insert component 2320 is selected, a timestamp 1004 (FIG. 10) comprising the comment is generated.

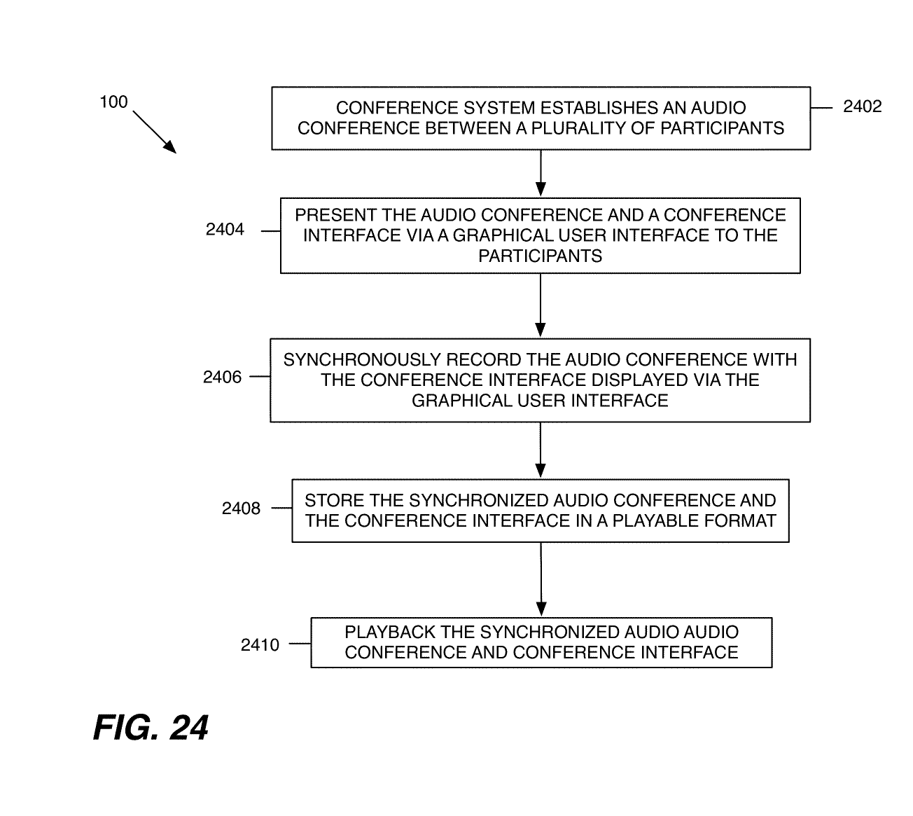

FIG. 24 is a flowchart illustrating the architecture, operation, and/or functionality of an embodiment of the computer system 100 of FIG. 1 for implementing the record/playback functionality. At block 2402, the conferencing system 106 establishes the audio conference 108 between a plurality of participants 104. At block 2404, the conference interface 600 and audio conference 108 are presented to the respective client devices 102. At block 2406, one or more of the client devices 102 synchronously record the audio conference 108 and one or more portions of the content presented in the conference interface 600. As mentioned above, one or more of the conference channels 124 may be recorded. At block 2408, the synchronized audio and/or video (and any other content presented in the conference interface 600) are stored and played back (block 2410) to the applicable participants 104.

It should be appreciated that the record/playback functionality may be configured in an “always on” record mode or operation, in which an online conference is automatically recorded. The “always on” mode may be configured as a default setting of conferencing system 106 in which all online conferences are automatically recorded. The “always on” mode may be selectively activated/deactivated by a participant 104 or controlled by the conference system 106, conference interface 600, or client 114 according to, for example, user account/profile settings or any other user-configurable rules. In an embodiment, a participant 104 may customize the “always on” mode to be active/inactive based on parameters, such as, user account, conference type (e.g., intra-company, department, public/private, etc.), specific participant(s), number of participants, day, time of day, agenda, etc.

One of ordinary skill in the art will appreciate that the “always on” mode provides a unique feature for enabling a participant 104 to join an online conference already in progress. For example, when a new participant 104 joins an online conference in progress (e.g., 15 minutes after the scheduled starting time) and assuming it has been recorded as described above, the new participant 104 may automatically, manually, or otherwise “rewind” the online conference to an earlier location or position on the conference timeline 1002 (FIG. 10). In response to receiving a request to join the online conference from the new participant 104, the conferencing system 106 may automatically initiate playback from a recording start location or any other “earlier” location, or alternatively prompt the new participant 104 via the conference interface 600 to specify whether to join live or from the start recording location. In other embodiments, the conferencing system 106 may initially add the new participant 104 to the live conference, and then prompt the new participant 104 to navigate to the recording start position or any earlier location.

It should be appreciated that the “always on” mode may be further configured to enable the new participant 104 to customize the recording start position. For example, upon joining an online conference already in progress, a new participant 104 may wish to begin playback at a specific conference event 1004 (FIG. 10) rather than the beginning of the online conference. The new participant 104 may specify to begin playback at any desirable event, including, for example, when a specific person entered the online conference, when a particular topic was discussed, when certain content has been shared or functionality activated via the conference interface 600, or based on any other desirable parameter, rule, etc.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the multi-platform virtual conference location system. Furthermore, the logical functions may be embodied in any computer readable medium for use by or in connection with an instruction execution system, apparatus, or device, such as a computer-based system, processor-containing system, or other system associated with the multi-platform virtual conference location system that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A method for providing an online conference, the method comprising:
scheduling an online conference for a first scheduled date/time;
a conferencing system establishing a first conference session for the online conference, at the first scheduled date/time, between a plurality of participants accessing the conferencing system via a communication network;
during the first conference session:
capturing content provided by one or more of the participants via a conference interface;
storing the captured content in association with the online conference;
determining that the online conference is to be suspended; and
scheduling a second scheduled date/time when the online conference is to be resumed in a second conference session;
the conferencing system ending the first conference session;
at the second scheduled date/time, the conferencing system establishing the second conference session between at least a portion of the participants; and
during the second conference session, presenting the captured content from the first conference session to one or more of the participants.

2. The method of claim 1, wherein the first and second conference sessions comprise an audio conference and the conference interface displays a participant object identifying each of the participants in the audio conference.

3. The method of claim 1, wherein the capturing the content provided by one or more of the participants via the conference interface comprises: synchronously recording an audio conference with the content presented in the conference interface.

4. The method of claim 3, wherein the presenting the captured content from the first conference session during the second conference session comprises playing back the synchronized audio conference and the content presented in the conference interface.

5. The method of claim 3, wherein the synchronously recording the audio conference with the content presented in the conference interface comprises:
capturing the content presented in the conference interface as a video stream; and
synchronizing the video stream with a plurality of audio streams comprising the audio conference

6. The method of claim 4, wherein the playing back the synchronized audio conference and the captured content further comprises presenting a navigation controller in the conference interface for navigating the synchronized audio conference and the captured content.

7. The method of claim 4, wherein the playing back the synchronized audio conference and the captured content comprises:
presenting a navigation controller via the conference interface;
receiving a navigation input associated with the navigation controller; and
playing back the synchronized audio conference and the captured content according to the navigation input.

8. The method of claim 1, wherein the captured content comprises one of an inserted audio stream, an inserted video stream, and an inserted document.

9. The method of claim 1, wherein the capturing the content via the conference interface comprises: receiving data from a conferencing application provided via the conference interface.

10. The method of claim 9, wherein the conferencing application comprises one or more of a notes application, a collaboration application, a chat application, and a messaging application.

11. The method of claim 1, wherein the capturing the content via the conference interface comprises receiving data from one or more conference channels.

12. The method of claim 1, wherein the scheduling the second scheduled date/time when the online conference is to be resumed comprises:
presenting a calendar via the conference interface; and
receiving a user selection of a date, a start time, and an end time.

13. The method of claim 1, wherein the determining that the online conference is to be suspended comprises receiving a suspension request from one of the participants via the conference interface.

14. The method of 1, wherein the determining that the online conference is to be suspended is based on a scheduled end time for the first conference session.

15. A computer program embodied in a computer readable medium and executable by a processor, the computer program for suspending and resuming an online conference initially scheduled for a first scheduled date/time, the computer program comprising logic configured to:
establish a first conference session for the online conference, at the first scheduled date/time, between a plurality of participants;
during the first conference session:
present a conference interface to one or more of the participants;
capture content provided by one or more of the participants via the conference interface; and
schedule a second scheduled date/time when the online conference is to be resumed in a second conference session;
establish the second conference session at the second scheduled date/time between at least a portion of the participants; and
during the second conference session, present the captured content from the first conference session to one or more of the participants.

16. The computer program of claim 15, wherein the logic configured to capture the content provided by one or more of the participants via the conference interface comprises: logic configured to synchronously record an audio conference with the content presented in the conference interface.

17. The computer program of claim 16, wherein the logic configured to present the captured content from the first conference session during the second conference session comprises logic configured to play back the synchronized audio conference and the content presented in the conference interface.

18. The computer program of claim 15, wherein the first and second conference sessions comprise an audio conference and the conference interface displays a participant object identifying each of the participants in the audio conference.

19. The computer program of claim 15, wherein the logic configured to capture the content provided by one or more of the participants via the conference interface comprises: logic configured to received data from a conferencing application provided via the conference interface.

20. The computer program of claim 19, wherein the conferencing application comprises one or more of a notes application, a collaboration application, a chat application, and a messaging application.
